(19) United States
(12) Patent Application Publication
(10) Pub. No.: US 2008/0025484 A1
(43) Pub. Date: Jan. 31, 2008

(54) COMPUTER INTEGRATED WITH TRADITIONAL TELEPHONE AND VOIP

(75) Inventors: Yu-Chih LIU, Taipei City (TW); Jhe-Jen Shih, Taipei City (TW); Shu-Fen Chen, Taipei City (TW)

Correspondence Address: LOWE HAUPTMAN HAM & BERNER, LLP, 1700 DIAGONAL ROAD, SUITE 300, ALEXANDRIA, VA, 22314, US

(73) Assignee: Asustek Computer Inc., Taipei City (TW)

(21) Appl. No.: 11/831,577

(22) Filed: Jul. 31, 2007

(30) Foreign Application Priority Data
Jul. 31, 2006 (TW) 095127997

(51) Int. Cl. H04M 11/00

(52) U.S. Cl. 379/93.05

(57) ABSTRACT

A computer integrated with traditional telephone and VoIP includes a network module, a south bridge chip and a telecom adapter module. The network module is connected to the Internet for providing an Internet connection function to enable the computer to make or receive a VoIP call. The south bridge chip is connected to the network module. The telecom adapter module includes a first telecom port for connecting to a traditional phone, a second telecom port for connecting to a PSTN, and a connection interface. The telecom adapter module is connected to the south bridge chip via the connection interface to thereby enable the traditional phone to make or answer a VoIP call via the telecom adapter module, the south bridge and the network module.

### BACKGROUND OF THE INVENTION

1. Field of the Invention

The invention relates to a computer and, more particularly, to a computer integrated with traditional telephone and VoIP.

2. Description of Related Art

Upon the evolution of computer telephony integration (CTI) technologies, VoIP (Voice over IP) phones have increasingly replaced traditional phones for a cheap and convenient communication tool. A typical VoIP phone generally uses a microphone and a speaker to electrically connect to a personal computer for placing a VoIP call.

The microphone can transmit voice, while the speaker can play received voice; however, they are not convenient to a user who habitually uses a traditional phone to make a call. Accordingly, some handset-like VoIP phones are marketed. Such VoIP phones have to be purchased additionally and are not compatible with the traditional phones, which add the cost and are inconvenient in use. For example, a VoIP call is answered by a VoIP phone, while a regular call is answered by a traditional phone.

Therefore, telecommunication providers provide an Internet telephony adapter box for conveniently using a traditional phone to make a VoIP call. As shown in FIG. 1, the Internet telephony adapter box 11 can connect a traditional phone 12 with a personal computer (PC) 13, such that the traditional phone can dial/answer a VoIP call. However, the adapter box 11 is additionally purchased and externally connected to the PC 13, which causes an inconvenience in use.

In addition, some information industrial manufacturers also provide a telecom adapter module implemented in a PC or notebook. As shown in FIG. 2, the telecom adapter module 20 has an RJ11 plug 21, a data access arrangement (DAA) unit 22, and a high definition (HD) voice coder/decoder (Codec) 23. The telecom adapter 20 is connected to the motherboard of the PC 25 via the HD voice interface. The RJ11 plug 21 is connected to the public switch telephone network (PSTN) 28. The PC 25 is connected to the Internet 29 to thereby use an earphone 251 and a microphone 252 to dial or answer a VoIP call. The VoIP call can be forwarded to a traditional phone via the telecom adapter module 20. In addition, a regular call can be made or answered by the PC 25.

As shown in FIG. 3, another telecom adapter module 30 has an RJ11 plug 31 and a DAA unit 32. The module 30 is connected to a notebook 35 via a modem daughter card (MDC) interface. The RJ11 plug 31 is connected to the PSTN 28. The notebook 35 is connected to the Internet 29 to thereby use an earphone 251 and an internal or external microphone 252 to dial or answer a VoIP call. The VoIP call can be forwarded to a traditional phone via the telecom adapter module 30. In addition, a regular call can be made or answered by the notebook 35.

The telecom adapter modules 20 and 30 essentially provide the functions of forwarding a VoIP call to the traditional phone connected to the PSTN and dialing or answering a regular call by the PC or notebook. However, dialing or answering a VoIP or traditional call is carried out with the earphone and microphone, while the traditional phone cannot dial/answer a VoIP call directly, which also causes an inconvenience in use.

### SUMMARY OF THE INVENTION

The object of the invention is to provide a computer integrated with traditional telephone and VoIP, which integrates the function of VoIP call forward into a computer in order to enable a traditional phone to dial/answer a VoIP call, thereby overcoming the problem in the prior art.

In order to achieve the object, a computer integrated with traditional telephone and VoIP is provided. The computer integrated with traditional telephone and VoIP includes a network module, a south bridge chip and a telecom adapter module. The network module is connected to the Internet for providing an Internet connection function to enable the computer to make or receive a VoIP call. The south bridge chip is connected to the network module. The telecom adapter module implemented in the computer includes a first telecom port for connecting to a traditional phone, a second telecom port for connecting to a PSTN, and a connection interface. The telecom adapter module is connected to the south bridge chip via the connection interface to thereby enable the traditional phone to make or answer a VoIP call via the telecom adapter module, the south bridge and the network module.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of using an Internet telephony adapter box to connect a traditional phone and a PC so as to enable the traditional phone to dial a VoIP call;

FIG. 2 is a schematic diagram of a typical telecom adapter module;

FIG. 3 is a schematic diagram of another typical telecom adapter module;

FIG. 4 is a functional block diagram of a computer integrated with traditional telephone and VoIP according to a preferred embodiment of the invention;

FIG. 5 is a block diagram of a telecom adapter module according to a preferred embodiment of the invention; and

FIG. 6 is a schematic view of an exterior of a computer integrated with traditional telephone and VoIP according to a preferred embodiment of the invention.

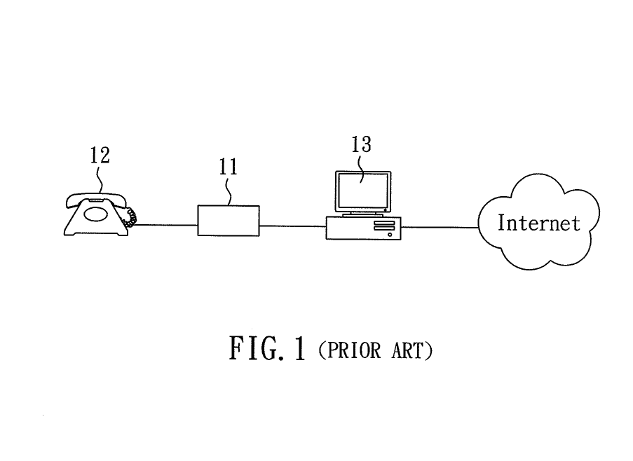

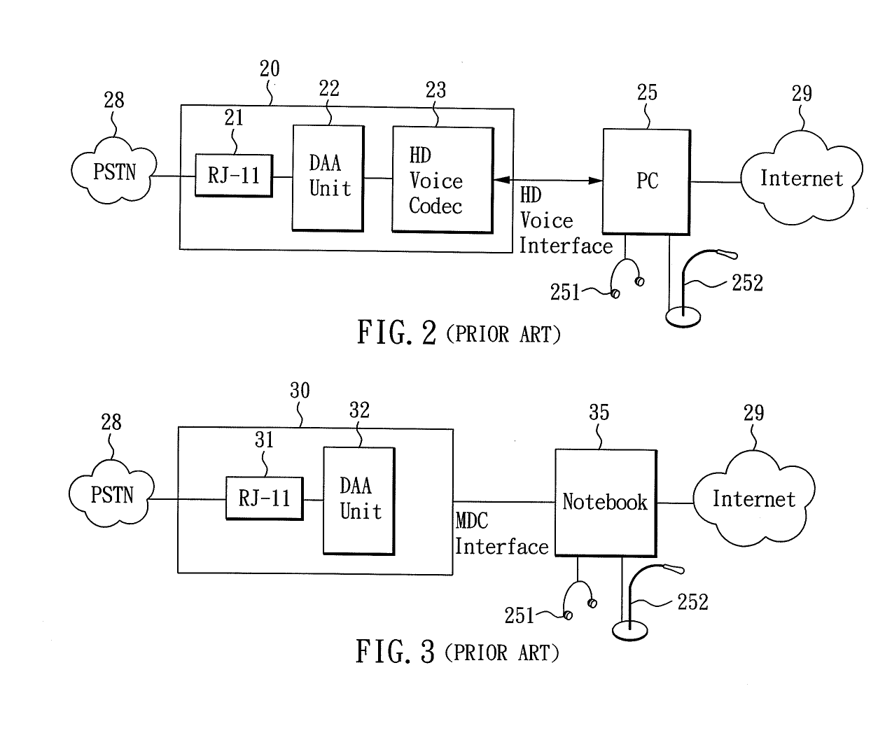

### DETAILED DESCRIPTION OF THE PREFERRED EMBODIMENT

Reference will now be made in detail to present embodiments of the present invention, examples of which are illustrated in the accompanying drawings. Wherever possible, the same reference numbers will be used throughout the drawings to refer to the same or like parts.

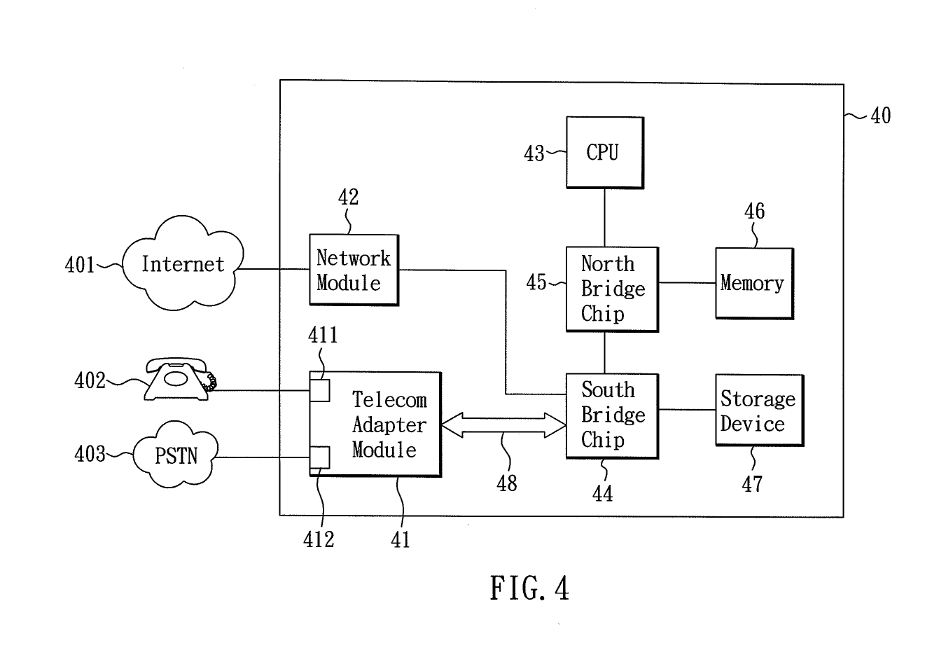

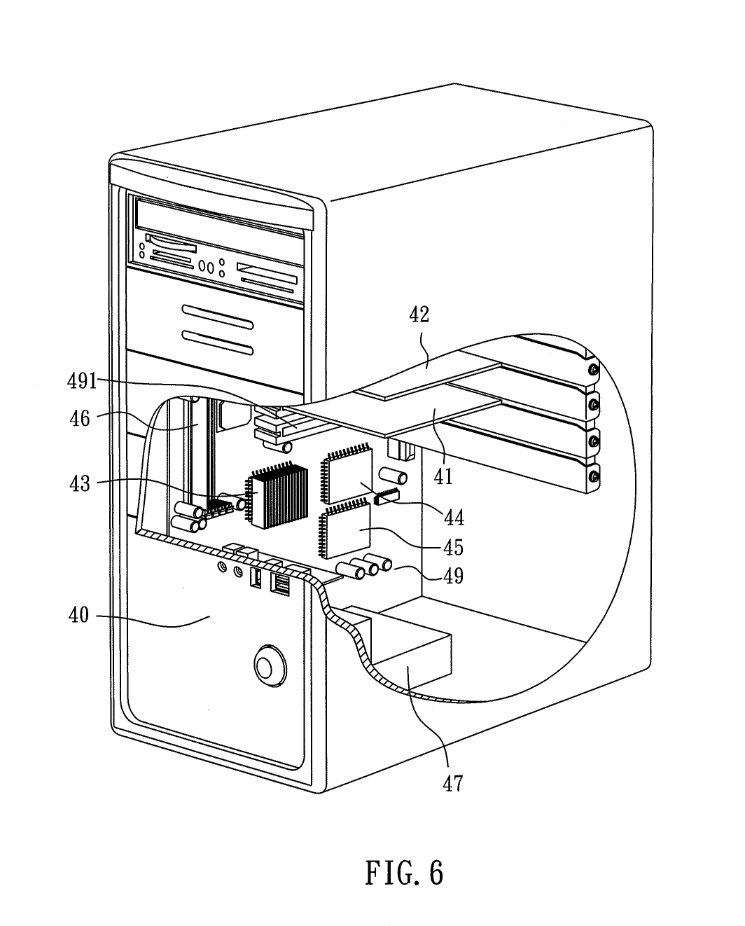

A preferred embodiment is given by referring to FIGS. 4 and 6. FIG. 4 is a functional block diagram of a computer integrated with traditional telephone and VoIP according to the preferred embodiment of the invention. FIG. 6 is a schematic view of an exterior of a computer integrated with traditional telephone and VoIP according to an embodiment of the invention. In this embodiment, the computer includes a telecom adapter (TA) module 41, a network module 42, a CPU 43, a south bridge chip 44, a north bridge chip 45, a memory 46, a storage device 47, a motherboard 49 and a case 40. The case 40 contains the motherboard 49, the TA module 41, the network module 42, the CPU 43, the south bridge chip 44, the north bridge chip 45, the memory 46 and the storage device 47. The CPU 43, the south bridge chip 44, the north bridge chip 45 and the memory 46 are implemented on the motherboard 49. The network module 42 and the TA module 41 are preferably in the form of extension card plugged into slots 491 on the motherboard 49. In other embodiments, the network module 42 can be a network chip embedded in or externally connected to the south bridge chip 44.

In this embodiment, the computer can be a desktop computer. In other embodiments, the computer can be a barebone, notebook, tablet PC, palmtop or Ultra Mobile PC (UMPC). In this embodiment, the storage device 47 can be a disk drive. In other embodiments, the storage device 47 can be a nonvolatile storage device such as a flash memory.

The CPU 43 executes the instructions of various applications to thereby control the operations of the computer. The storage device 47 is connected to the south bridge chip 44 and stores the data and applications. For example, the storage device 47 can store operating systems, video data, VoIP software programs, applications associated with the telecom adapter module 41, or other applications. The memory 46 is connected to the north bridge chip 45 and stores the data and applications required for the CPU 43 in operation.

The north bridge chip 45 is connected to the CPU 43, the memory 46 and the south bridge chip 44 in order to operate with the CPU 43, control the data readout and write-in of the memory 46, control the bus, and transfer the data from/to the south bridge chip 44. The south bridge chip 44 is connected to the telecom adapter module 41, the network module 42 and the storage device 47, and connected with the CPU 45 through the north bridge chip 45. The south bridge chip 44 plays a role of communicating with the input/output interfaces and the peripherals.

The network module 42 can be connected to the Internet 401 in a wireless or wired manner for providing an online function to the computer. In this embodiment, the network module 42 is an Ethernet network card. In other embodiments, the network module 42 can be a wireless network card. Thus, the computer can be connected to the Internet 401 via the network module 42, and executes VoIP software (for example, Skype) and an application associated with the telecom adapter module 41 while setting an online connection with the Internet 401. Accordingly, a user can use the traditional phone 402 and the computer to dial/answer a VoIP call.

The telecom adapter module 41 includes a first telecom port 411 and a second telecom port 412. The first telecom port 411 is connected to the traditional phone 402, and the second telecom port 412 is connected to the PSTN 403. In addition, the telecom adapter module 41 is connected to the south bridge chip 44 via the connection interface 48. In this embodiment, the first and the second telecom ports 411 and 412 are RJ11 ports respectively. In other embodiments, the first and the second telecom ports 411 and 412 can be t connection ports of other types.

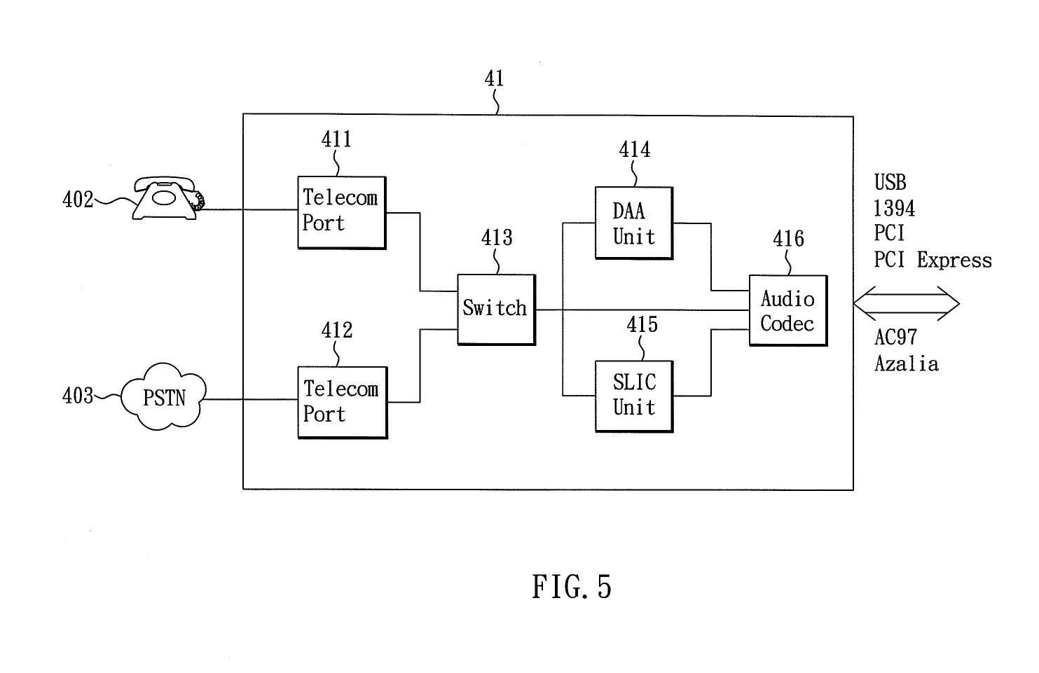

FIG. 5 is a block diagram of the telecom adapter module 41 according to an embodiment of the invention. As shown in FIG. 5, the telecom adapter module 41 includes the first telecom port 411, the second telecom port 412, a switch 413, a data access arrangement (DAA) unit 414, a subscriber line interface circuit (SLIC) unit 415, and an audio codec (coder/decoder) 416.

The switch 413 is connected to the first telecom port 411, the second telecom port 412, the DAA unit 414, the SLIC unit 415 and the audio codec 416 in order to switch the connection relation and call mode between the first and second telecom ports 411, 412 and the DAA and SLIC units 414, 415 according to a control of the audio codec 416.

For example, in a regular mode, the switch 413 switches the first telecom port 411 to electrically connect with the second telecom port 412. Accordingly, the traditional phone 402 can dial a call to the PSTN 403 or answer a call switched from the PSTN 403 as usual. In the VoIP mode, the switch 413 switches the first telecom port 411 to electrically connect with the DAA unit 414 or the SLIC unit 415. Accordingly, the traditional phone 402 can dial/answer a VoIP call through the telecom adapter module 41, the south bridge chip 44 and the network module 42. It is noted that the first telecom port 411 is not electrically connected to the second telecom port 412 in the VoIP mode. In other embodiments, the path switching provided by the switch 413 can be alternated, depending on the functions provided by the telecom adapter module 41.

In this embodiment, the functions provided by the DAA unit 414 and the SLIC unit 415 are similar to those provided by the typical DAA unit and the typical SLIC unit. Namely, the typical SLIC unit is implemented at the telecommunication company side, and provides the voltage to the traditional phone. The typical DAA unit is implemented at the traditional phone side. In this embodiment, the DAA unit 414 is corresponding to the SLIC unit implemented in the telecommunication end office, so as to provide a user at the network side to simulate a dial phone through the DAA unit 414, and the traditional phone 402 can be used to answer a VoIP call through the SLIC unit 415.

Specifically, the DAA unit 414 can provide the power extraction and the analog phone simulation to thereby answer a VoIP call, and convert a digital IP-based call into an analog signal used by a local PSTN. The SLIC unit 415 can provide the power feed, the dial tone, and the closed loop provided for detecting the traditional phone 402.

The audio codec 416 is connected to the switch 413, the DAA unit 414, the SLIC unit 415 and the connection interface 48. In this embodiment, the audio codec 416 can provide a control function, voice coding and decoding functions, control the operations of the switch 413, DAA unit 414 and SLIC unit 415, and perform the conversion between analog and digital voice signals.

In this embodiment, the telecom adapter module 41 is in a form of extension card plugged into the motherboard of the computer. In other embodiments, the telecom adapter module 41 can be integrated directly into the motherboard. In this embodiment, the connection interface 48 is a universal serial bus (USB) interface. In other embodiments, the connection interface 48 can be an interface such as IEEE 1394, PCI, PCI Express, AC97 or Azalia.

The function and operation of the telecom adapter module 41 integrated in the computer is further described as follows.

As shown in FIGS. 4 and 5, in the regular mode, the switch 413 switches the first telecom port 411 to electrically connect with the second telecom port 412. Accordingly, a user can use the traditional phone to dial/answer a call to/from the PSTN as usual, without changing the operation.

When a user desires to make a VoIP call, the user can press down a predetermined key (such as the key “*”) on the traditional phone 402 to enable the switch 413 to change the connection of the first telecom port 411. For example, the user presses down the predetermined key on the traditional phone 402, and the audio codec 416 controls the switch 413 to perform a switch according to the dual tone multi-frequency (DTMF) signal corresponding to the predetermined key. Accordingly, the first telecom port 411 is electrically connected with the DAA unit 414 through the switch 413, and the traditional phone 402 can dial a VoIP call through the telecom adapter module 41, the south bridge chip 44 and the network module 42.

After the predetermined key is pressed down to switch the connection to the VoIP mode, the user can press down a predetermined speed-dialing number to further dial a VoIP call. For example, the user presses down a speed-dialing number 111, which indicates the first friend “AAA” of an address book set in the VoIP software, through the traditional phone 402 to thereby enable a VoIP call to the friend “AAA”. In addition, after the speed-dialing number is pressed down, the DAA unit 414 can produce the dialing operation, and the audio codec 416 converts the analog voice signal produced by the DAA unit 414 into a digital voice signal and sends the digital voice signal to the south bridge chip 44 through the connection interface 48. The digital voice signal is sent to the Internet 401 through the network module 42. In other embodiments, the user can press a set of predetermined keys, for example “*77”, to switch the connection to the VoIP mode.

Similarly, when a VoIP call is to be made from the Internet 401 to the computer, the audio codec 416 controls the switch 413 to perform a switch, so that the traditional phone 402 can answer the VoIP call through the SLIC unit 415. In other embodiments, the switch 413 switches the second telecom port 412 to electrically connect with the DAA unit 414. Accordingly, the VoIP call can be forwarded through the PSTN 403 to another traditional phone or a cellphone preset by other users.

In view of the foregoing, it is known that the invention enables the traditional phone to dial/answer a VoIP call by integrating the telecom adapter module into the computer and switching a connection of the telecom adapter module. Further, since the telecom adapter module is integrated directly into the computer, there are no compatibility and control problems encountered.

Although the present invention has been explained in relation to its preferred embodiment, it is to be understood that many other possible modifications and variations can be made without departing from the spirit and scope of the invention as hereinafter claimed.

What is claimed is:

1. A computer integrated with traditional telephone and VoIP, comprising:
a network module, used for connecting to the Internet for providing an Internet connection function to enable the computer to make or receive a VoIP call;
a south bridge chip, connected to the network module; and
a telecom adapter module, implemented in the computer and including a first telecom port for connecting to a traditional phone, a second telecom port for connecting to a public switch telephone network (PSTN), and a connection interface, the telecom adapter module being connected to the south bridge chip via the connection interface to thereby enable the traditional phone to make or answer a VoIP call via the telecom adapter module, the south bridge and the network module.

2. The computer as claimed in claim 1, further comprising a motherboard on which the network module, the south bridge chip and the telecom adapter module are implemented, and a case to contain the motherboard.

3. The computer as claimed in claim 1, further comprising a central processing unit (CPU) and a north bridge chip connected between the CPU and the south bridge chip.

4. The computer as claimed in claim 3, further comprising a memory connected to the north bridge chip and storing data and applications required for the CPU in operation.

5. The computer as claimed in claim 1, further comprising a storage device connected to the south bridge chip and permanently storing data and applications.

6. The computer as claimed in claim 1, wherein the connection interface is a universal serial bus (USB) interface.

7. The computer as claimed in claim 1, further comprising a motherboard having a slot to receive the telecom adapter module which is implemented as an extension card.

8. The computer as claimed in claim 1, wherein the telecom adapter module further comprises:
a data access arrangement (DAA) unit;
a subscriber line interface circuit (SLIC) unit;
an audio coder/decoder (codec), connected to the DAA unit, the SLIC unit and the connection interface in order to perform a conversion between analog and digital voice signals; and
a switch, connected to the first telecom port, the second telecom port, the DAA unit, the SLIC unit and the audio codec in order to switch a connection between the first and second telecom ports and the DAA and SLIC units according to a control of the audio codec.

9. The computer as claimed in claim 8, wherein the switch in a regular mode switches the first telecom port to electrically connect with the second telecom port.

10. The computer as claimed in claim 8, wherein the switch in a VoIP mode switches the first telecom port to electrically connect with the DAA unit, so that the traditional phone is enabled to dial the VoIP call through the telecom adapter module, the south bridge chip and the network module.

11. The computer as claimed in claim 8, wherein the switch in a VoIP mode switches the first telecom port to electrically connect with the SLIC unit, so that the traditional phone is enabled to answer the VoIP call through the telecom adapter module, the south bridge chip and the network module.
